(19) United States
(12) Patent Application Publication
(10) Pub. No.: US 2006/0243543 A1
(43) Pub. Date: Nov. 2, 2006

(54) Bicycle handbrake operating device with bearing

(76) Inventor: Szu-Fang Tsai, Chang-Hua Hsien (TW)

Correspondence Address: LEONG C LEI, PMB # 1008, 1867 YGNACIO VALLEY ROAD, WALNUT CREEK, CA, 94598, US

(21) Appl. No.: 11/115,148

(22) Filed: Apr. 27, 2005

(51) Int. Cl. F16D 65/14

(52) U.S. Cl. 188/24.22; 188/2 D

(57) ABSTRACT

A bicycle handbrake operating device is provided, which contains a positioning seat and an operating lever. A brake cable is joined to an end of the operating lever so that, when the operating lever is gripped to pivot around its pivoting hole, the brake cable is pulled to stop the bicycle. The handbrake operating device utilizes two metal bearings positioned above and beneath the pivoting hole of the operating lever respectively, and the locking screw is threaded through the bearings and the pivoting hole. Each of the bearings contains a ring cover and a tubular bearing seat. Inside the bearing seat, a number of steel balls are arranged along the circumference of the bearing seat. The addition of the bearings contributes to an even smoother operation and a prolonged operation life for the operating lever.

### BACKGROUND OF THE INVENTION

(a) Technical Field of the Invention

The present invention generally relates to bicycle handbrakes, and more specifically to a bicycle handbrake operating device using bearings to enhance handbrake sensitivity and efficiency.

(b) Description of the Prior Art

Please refer to FIG. 1, which shows a conventional bicycle handbrake operating device. As illustrated, a conventional handbrake operating device 1 mainly contains a positioning seat 11 and an operating lever 12. A brake cable (not shown) is threaded through a cabling screw 13 installed on an end of the positioning seat 11 and then joined to an end section 121 of the operating lever 12. The end section 121 of the operating lever 12 has a pivoting hole 122 configured correspondingly to the through holes 111 of the positioning seat 11, and the operating lever 12 is pin-joined to the positioning seat 111 by a locking screw 14 threaded through the through holes 111 and the pivoting hole 122. In addition, a spring 16 is configured against the operating lever 12 and the positioning seat 11. When a user grips the operating lever 12, it pivots around the locking screw 14. The spring 16 is twisted and the brake cable is pulled to stop the bicycle. When the operating lever 12 is then released, the spring 16 exerts a force to return the operating lever 12 back to its original position.

The forgoing structure has been adopted in the industry for a long time. However, conventionally, two plastic washers 15 are positioned above and beneath the pivoting hole 122, and are threaded through by the locking screw 14 so as to reduce the friction encountered when the operating lever 12 is gripped and when it is released to return to its original position.

The problem lies in that, after a period of use, the washers 15 usually become thin, deformed, or even broken. The operating lever 12 therefore becomes loosed, reducing significantly the effectiveness and the performance of the handbrake. Even though the plastic washers 15 could indeed effectively lessen the function from the metal locking screw 14's pivoting against the metal operating lever 12, the operation life of the plastic washers 15 are quire limited under constant back-and-forth rubbing.

### SUMMARY OF THE INVENTION

The primary purpose of the present invention is to provide a bicycle handbrake operating device to overcome the foregoing problem of the conventional handbrake operating devices. The present invention relies on a simple principle that rolling encounters less friction than sliding. As such, the present invention utilizes two metal bearings positioned above and beneath the pivoting hole of the operating lever respectively. The locking screw pin-joins the positioning seat and the operating lever is threaded through the top bearing, the pivoting hole of the operating lever, and then the bottom bearing. Each of the bearings contains a ring cover and a tubular bearing seat. Inside the bearing seat, a number of steel balls are arranged along the circumference of the bearing seat. The ring cover then seals the steel balls inside the bearing seat. The addition of the bearings contributes to an even smoother operation and a prolonged operation life for the operating lever.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an explosion view of a conventional handbrake operating device.

FIG. 2 is a perspective view showing a handbrake operating device according to an embodiment of the present invention.

FIG. 3 is a perspective explosion view showing the handbrake operation device of FIG. 2.

FIG. 4 is a perspective explosion view showing a bearing of the handbrake operation device of FIG. 2

FIG. 5 is a section view showing the handbrake operation device of FIG. 2.

FIG. 6 is a schematic view showing an operation scenario of the handbrake operation device of FIG. 2.

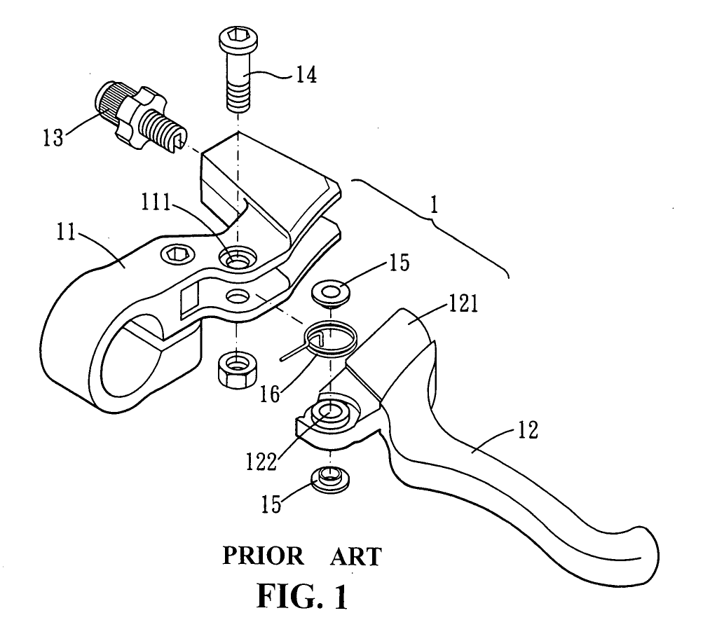

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

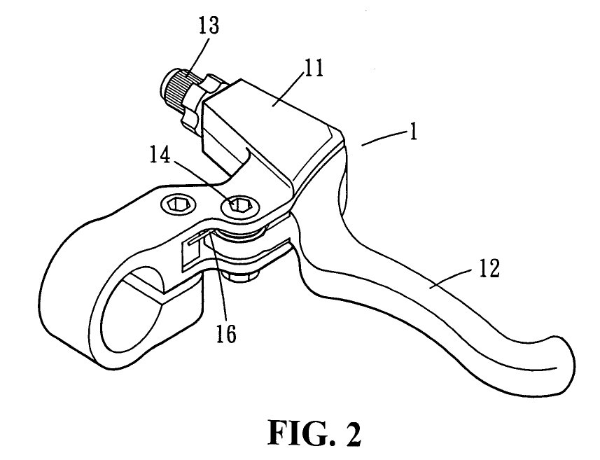

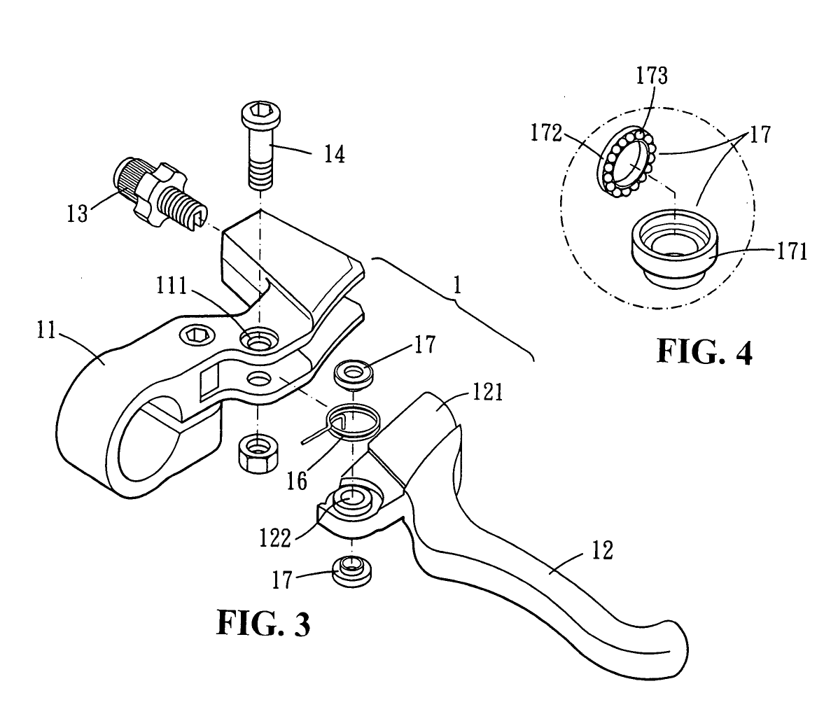

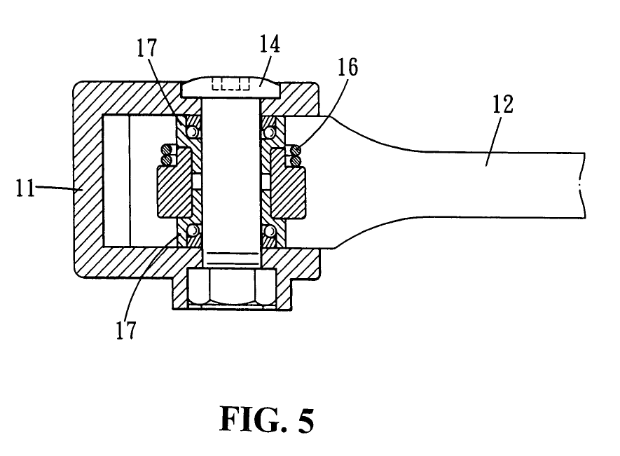

Please refer to FIGS. 2 to 5. A handbrake operating device 1 according to an embodiment of the present invention mainly contains a positioning seat 11 and an operating lever 12. An end section 121 of the operating lever 12 is housed in a chamber (not numbered) of the positioning seat 11 so that a pivoting hole 122 in the end section 121 of the operating lever 12 is positioned right between two through holes 111 on the top and bottom walls (not numbered) of the chamber respectively. The operating lever 12 is pin-joined to the positioning seat 11 by a locking screw 14 threaded through the through holes 111 and the pivoting hole 122 so that the operating lever 12 could pivot around the locking screw 14.

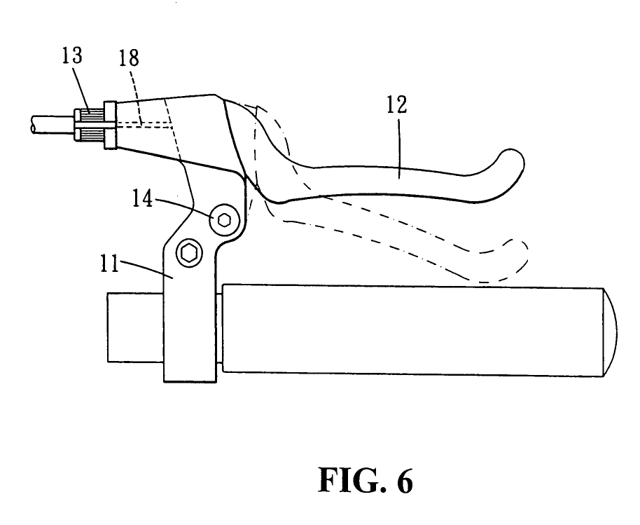

A brake cable 18 (see FIG. 6) is threaded into the chamber of the positioning seat 111 via a cabling screw 13 installed on an end of the positioning seat 11 opposite horizontally to the chamber and the end section 121 of the operating lever 12. The brake cable is then directly or indirectly joined to the end section 121 of the operating lever 12. When the locking screw 14 pin-joins the positioning seat 11 and the operating lever 12 together, it also passes through a spring 16 positioned between the pivoting hole 122 and the top wall of the chamber.

When a user grips the operating lever 12, it pivots around the locking screw 14. The spring 16 is twisted and the brake cable is pulled to stop the bicycle. When the operating lever 12 is then released, the spring 16 exerts a force to return the end section 121 of the operating lever 12 back to the chamber automatically.

The most significant feature of the present invention is that the two bearings 17 are installed between the top wall of the chamber and the pivoting hole 122, and between the pivoting hole 122 and the bottom wall of the chamber respectively. When the locking screw 14 pin-joins the positioning seat 11 and the operating lever 12 together, it also passes through the two metal bearings 17. Each of the bearings 17 contains a ring cover 172 and a tubular bearing seat 171. The bearing seat 171 has a top section (not numbered) with a larger diameter and a bottom section (not numbered) with a smaller diameter. Inside the top section of the bearing seat 171, a number of steel balls 173 are arranged along the circumference of the top section of the bearing seat 171. The ring cover 172 then seals the steel balls 173 inside the bearing seat 171. The addition of the bearings 17 contributes to an even smoother operation and a prolonged operation life for the operating lever 12.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bicycle handbrake operating device for a bicycle comprising a positioning seat and an operating lever;
wherein a cabling screw is installed to an end of said positioning seat through which a brake cable is threaded and joined to an end of said operating lever;
a pivoting hole of said operating lever is configured correspondingly to through holes on said positioning seat so that a locking screw is threaded through said pivoting and through holes to pin-join said operating lever and said positioning seat together;
said operating lever pivots around said locking screw when it is gripped so that said brake cable is pulled to stop said bicycle;
a spring is configured against said operating lever and said positioning seat so that, when said operating lever is gripped and released, said spring exerts a force to return said operating lever to its original position;
metal bearings are positioned above and beneath said pivoting hole of said operating lever respectively, and said locking screw pin-joining is threaded through said bearings and said pivoting hole; and
each of said bearings contains a ring cover and a tubular bearing seat sealed by said ring cover, within which a plurality of steel balls are arranged along the circumference of said bearing seat so as to provide a smoother operation and a prolonged operation life for said operating lever.
